(19) United States
(12) Patent Application Publication
(10) Pub. No.: US 2005/0266925 A1
(43) Pub. Date: Dec. 1, 2005

(54) System and method for an online duel game

(75) Inventors: Karl H. Hornell, Uppsala (SE); Erik F. Hornell, Uppsala (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Ongame e-solutions AB

(21) Appl. No.: 10/852,857

(22) Filed: May 25, 2004

(51) Int. Cl. G06F 19/00; G06F 17/00

(52) U.S. Cl. 463/42

(57) ABSTRACT

A network system and network method perform a pyramid tournament duel game, such as a Rock-Paper-Scissors duel game, between at least two participants online a network for data- and telecommunication such as the Internet. Network software is used for performing the online game and a readable storage medium stores the network software.

### TECHNICAL FIELD

The present invention pertains to a network system and network method for performing a multilevel tournament duel game, such as a Rock-Paper-Scissors duel game, between at least two participants online a network for data- and telecommunication, such as the Internet. The invention also pertains to network software for performing said online game and a readable storage medium storing said network software.

### BACKGROUND ART

Man has since the dawn of times been drawn to games and gambling for the thrill and prospect of easy earnings and for the credit given to a winner.

In modern times, communication networks such as the Internet is, among other things, utilized as a global meeting place for people seeking to gamble and play games against each other or versus “the machine” online, which for example could be a software implemented machine provided by a game server. The popularity of Internet casinos for online poker play against other physical participants is steadily increasing. The players then only have to register an individual player account and provide some betting money to be able to start playing poker against each other online. Internet casinos often also offer a variety of other traditional casino games such as blackjack, roulette, fruit machines and so forth where a man gambles against “the machine”, for the sake of monetary or other rewards given by the casino.

People are however generally more interested in playing or gambling against one another than against “a machine”, probably due to the machines inherent lack of human intelligence, emotions and other such human factors influencing the outcome of a game. Poker and most online games for money between people require a certain degree of skill and game knowledge for a player to be able to play effectively, i.e. the outcome of a game mostly depends on the skill of the player. A person not wanting to risk his/her money when lacking such game skills, and not being interested in acquiring such skills through practice, but still wanting to participate and experience the thrill of a network game for money against other people, is currently falling short of opportunities.

The ancient game of Rock Paper Scissors, RPS, is a very popular man-to-man game known by most people already at childhood. RPS has traditionally been a decision making game of wits, speed, dexterity and strategy between players who are unable to reach a decision using other means. It is also known in parts of the world as Jenken, Jan Ken Pon, Roshambo, Shnik Shnak Shnuk, Ching Chong Chow, Farggling, Scissors Paper Stone, Scissors Rock Paper, Sten Sax Pase, among many others. The result of a game has been considered a binding agreement between the players. The game is very simple to learn and understand and is played by substituting the elements of: Rock, Paper and Scissors with standard hand signals and it is believed to be at least 500 years old or more.

According to the traditional game rules, Rock wins against Scissors, loses to Paper 5 and stalemates against itself. Paper wins against Rock, loses to Scissors and stalemates against itself. Scissors wins against Paper, loses to Rock and stalemates against itself. In other words Rock smashes or blunts Scissors, Scissors cuts Paper and Paper covers Rock.

The popularity of RPS together with new technology has brought forth some alternative ways of playing the game other than the traditional way of hand signaling. The Japanese patent application 10191155, for example discloses a rock-paper-scissors device including a control panel and a display, displaying a main character and three opponent characters on a game screen. A rock-paper-scissors game button is adapted for selecting the kind of motion (scissors, stone, paper) of the main character and serves as the start button for starting a rock-scissors-paper game. Also provided on the device is a bet button for setting gambling rate, a medal slot for inserting medals, a dispensing button and a medal eject hole for taking out medals won.

The Japanese patent application 2001000809 in turn shows a system and method for a rock-paper-scissors or janken battle game in a network environment. The game comprises a janken battle server connected with terminal devices such as personal computers or mobile appliances through a communication network. The battle server provides a janken battle game through janken cards to participants who have joined from the terminal devices through the communication network. The cards comprise a combination of janken hands indicating the basic characteristics of janken, and characters indicating secondary characteristics by pictures.

JP2000261960 discloses a stepping type game device for a scissors-paper-rock game comprising a scissors-paper-rock game button on respective steps of a left and a right staircase. A player who has won the scissors-paper-rock game climbs one step of the staircase, and a player who has lost comes down one step of the staircase. The player who reaches the uppermost step wins the game.

The Japanese patent applications JP11061627 and JP11096706 each show a machine for a game of rock-scissors-paper.

The prior art systems, methods and devices for performing a game of rock-scissors-paper all lack the means for providing an online multi player tournament duel scenario, where a multitude of players are given the opportunity to meet each other in real-time RPS duels for stakes increasing with every win.

### SUMMARY OF THE DISCLOSED INVENTION

The present invention relates to a network system and network method for performing a tournament duel game, such as a Rock-Paper-Scissors duel game, incorporating bets between at least two participants online a network for data- and telecommunication, such as the Internet. The invention also pertains to a network software for performing said online game and a readable storage medium storing said network software.

One aspect of the invention is to provide such a network system and method, and such network software stored on a readable medium, for performing a real time network game for a reward, which requires a minimum of forehand knowledge and skill and which is quick, fun and exciting to play.

To achieve aims and objectives the present invention provides a network system 15 including a game server and a game database connected to the server for storing at least one of game data and registered player data, for performing an online multilevel tournament duel game, hosted on the server connected to an open network for data and telecommunication, between at least two participants through a network connection via a respective computerized device with a screen. The network system further comprises:

a game entry means, for activating a player avatar on a certain game level of a preset number of total game levels depending on the size of a game bet provided from a predefined game account;

a pairing means, for checking if an opponent player is available on the current game level, and when an available opponent is found;

a dueling means, for simultaneously opening up a duel window on both players' respective screens and upon which a countdown clock is started, for performing at least one duel match wherein each player is prompted to actively select, on the respective computerized screen, one of three different duel symbols each symbol being first to one of the other two symbols and second to the other of said other two symbols, displayed in said window within a preset timeframe of said clock;

a random selection means, for randomly selecting a duel symbol alternative to a player not having selected a button within said timeframe; and

a symbol comparing means, for comparing the duel symbol selected for the player with that of the opponent when said timeframe has passed, wherein if the symbols upon comparison are found equal, the countdown clock is reset and the duel match is repeated, and wherein if the symbols are found not equal, the selected symbol being first to the other symbol selected determines the duel match winner;

wherein the system is arranged so that the winner of at least one duel match, through a level advancing means, advances one level in the game, doubles the bet amount and in said duel window is prompted, via a winner selection means, to select one of transfer winnings to said predefined account upon ending the game and engage a new duel match on the new game level, and wherein the system is arranged so that the loser of said at least one duel match, through an eliminating means, is momentarily eliminated from said multilevel game.

One embodiment of the system according to the present invention further comprises a duel match win indicating means for at least one of a graphical and an audible indication of a duel match win.

Another embodiment of the system according to the present invention further comprises a duel match loss indicating means for at least one of a graphical and an audible indication of a duel match loss. Yet another embodiment of the system according to the present invention further comprises a duel match win counting means arranged so that the first participant to reach three duel matches won wins the duel.

A further embodiment of the system according to the present invention further comprises a messaging means for the participants to communicate with one another during a duel and/or when waiting for a duel.

In another embodiment of the system according to the present invention, the messaging means utilizes at least one of ICO, SMS, email, or the like such known means for real time or time delayed messaging.

In yet another embodiment of the system according to the present invention, the messaging means utilizes means for voice connection between the participants through at least one of headsets, and loudspeakers and microphones connected to their respective computerized devices.

An additional embodiment of the system according to the present invention further comprises a lobby interface means for adjusting the settings of a game, such as to enable/disable sound and for determining which of several different ongoing tournament duel games to enter.

Furthermore the present invention sets forth a network method for performing an online multilevel tournament duel game between at least two participants being connected to an open network for data and telecommunication through a respective computerized device with a screen wherein a network game server hosts said game and a network game database connected to said server stores at least one of game data and registered player data. The method comprises the method steps of:

activating a player avatar on a certain game level of a preset number of total game levels depending on the size of a game bet provided from a predefined game account through a game entry means;

checking if an opponent player is available on the current game level through a pairing means, and when an available opponent is found;

simultaneously opening up a duel window on both players' respective screens upon which a countdown clock is started, through a dueling means for performing at least one duel match wherein each player is prompted to actively select, on the respective computerized screen, one of three different duel symbols each symbol being first to one of the other two symbols and second to the other of said other two symbols, displayed in the window within a preset timeframe of the clock;

randomly selecting a duel symbol alternative to a player not having selected a button within the timeframe through a random selection means; and

comparing the duel symbol selected for the player with that of the opponent when the timeframe has passed through a symbol comparing means, wherein if the symbols upon comparison are found equal, the countdown clock is reset and the duel match is repeated, and wherein if the symbols are found not equal, the selected symbol being first to the other symbol selected determines the duel match winner;

wherein the winner of at least one duel match, through a level advancing means, advances one level in the game, doubles the bet amount and in the duel window is prompted, via a winner selection means, to select one of transfer winnings to the predefined account upon ending the game and engage a new duel match on the new game level, wherein the loser of the at least one duel match, through an eliminating means, is momentarily eliminated from the multilevel game.

The method of the present invention is able to perform method steps of the above system embodiments in accordance with attached method dependent claims.

The present invention also sets forth network software for performing an online multilevel tournament duel game hosted on a server connected to an open network for data and telecommunication, between at least two participants through a network connection via a respective computerized device with a screen. The software comprises:

a game entry means, for activating a player avatar on a certain game level of a preset number of total game levels depending on the size of a game bet provided from a predefined game account;

a pairing means, for checking if an opponent player is available on the current game level, and when an available opponent is found; a dueling means, for simultaneously opening up a duel window on both players' respective screens and upon which a countdown clock is started, for performing at least one duel match wherein each player is prompted to actively select, on the respective computerized screen, one of three different duel symbols each symbol being first to one of the other two symbols and second to the other of the other two symbols, displayed in the window within a preset timeframe of the clock;

a random selection means, for randomly selecting a duel symbol alternative for a player not having selected a button within the timeframe; and

a symbol comparing means, for comparing the duel symbol selected for the player with that of the opponent when the timeframe has passed, wherein if the symbols upon comparison are found equal, the countdown clock is reset and the duel match is repeated, and wherein if the symbols are found not equal, the selected symbol being first to the other symbol selected determines the duel match winner; wherein the software is arranged so that the winner of at least one duel match, through a level advancing means, advances one level in the game, doubles the bet amount and in the duel window is prompted, via a winner selection means, to select one of transfer winnings to said predefined account upon ending the game and engage a new duel match on the new game level, and wherein the software is arranged so that the loser of the at least one duel match, through an eliminating means, is momentarily eliminated from the multilevel game.

The present invention also sets forth a readable storage medium storing the network software described above, for performing an online multilevel tournament duel game.

### BRIEF DESCRIPTION OF THE DRAWINGS

Henceforth reference is had to the attached figures for a better understanding of the present invention and its examples and embodiments, wherein:

FIG. 1 schematically shows the connection of hardware components 10, 20, 30, 40 required for performing an online tournament duel game, such as a rock-scissors-paper duel game, between multiple participants according to one embodiment of the invention;

FIG. 2 schematically illustrates a graphical presentation of an online pyramid tournament game of rock, scissors and paper between multiple participants 60, according to a preferred embodiment of the present invention.

FIG. 3 schematically illustrates a graphical presentation of a duel window 200 for the online pyramid tournament game of rock, scissors and paper between multiple participants of FIG. 2.

FIG. 4 schematically depicts a flowchart of events for an online pyramid tournament duel game 300 of rock-scissors-paper matches between multiple participants for monetary rewards;

FIG. 5 in a flowchart illustrates the events of a duel 340 between two participants of the tournament duel game 300.

### WORDLIST

RPS is the abbreviation for rock-paper-scissors.
Stalemate or mirror play is when the same symbol is chosen simultaneously by both participants during a game of RPS.
An open network for data communication can be the WWW or other like open networks, intranet etc.
A computerized device with a screen can be a stationary computer, a laptop computer, a PDA or the like comprising cellular radio equipment or a WAP telephone device etc.
WAP (Wireless Application Protocol) enables a WWW connection through a cellular telephone.
A PDA (Personal Digital Assistant) is a handheld computer that serves as an organizer for personal information.

### DETAILED DESCRIPTION OF PREFERRED EMBODIMENTS

The present invention sets forth a network system and a network method for performing an online pyramid tournament game of man-to-man duels, for example rock-paper-scissors (RPS) duels, between at least two participants on an open network for data and telecommunication, such as the Internet. The invention also pertains to network software for performing said online game and a readable storage medium storing said network software.

The online game accomplished according the invention provides the opportunity for a multitude of players to meet each other in duels, such as RPS duels, for stakes, which increase with every win. The loser of each duel is momentarily eliminated from the game losing his/her stake, while the winner of a duel gains said stakes and advances to a new game level at which a new duel can be accepted for a furthermore raised stake.

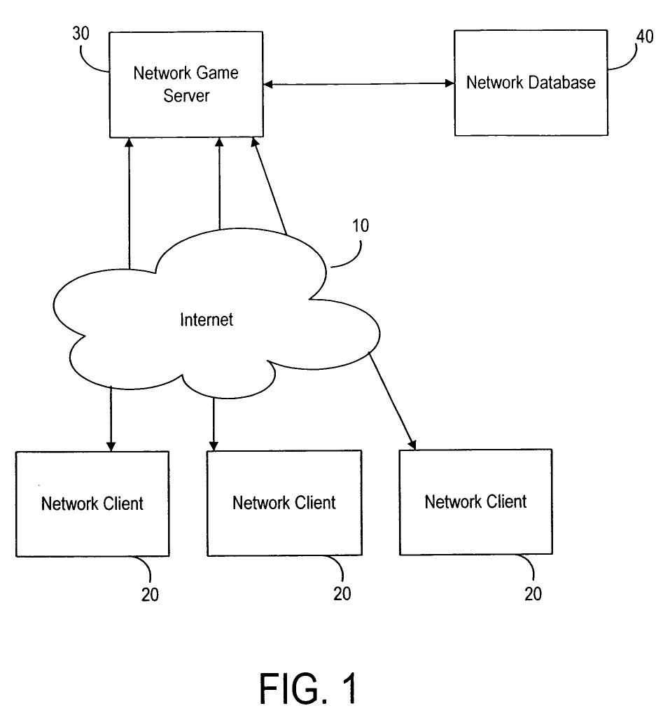

In FIG. 1, according to one embodiment of the invention, the game is for example provided on an Internet 10 webpage to the screens of network clients 20 through means of a network game server 30 being connected to a network database 40 storing both personal data and game data of game participants. A person wanting to participate in a game, for 5 example, enters the portal or webpage on which the game is hosted and run graphically through said server software means via a network client, such as computerized device provided with a digital screen and being connected, wirelessly or through cable, to the network, such as the Internet.

The web-based pyramid tournament game offers a number of simultaneous participants, being connected to said game server hosted webpage through their respective computerized devices with screens, the opportunity to compete and play against one another for a reward, which could be a valuable or monetary reward or a point-based reward for a game ranking purpose or a bonus program purpose, in a series of man-to-man duels. The duels are, according to one embodiment of the invention, designed to be principally 15 knowledge- and skill neutral and are, for example, decided through rock-scissors-paper or Janken matches. The duels could alternatively be accomplished through dice, card or quiz matches or the like.

The game comprises a number of levels and a participant only duel with an opponent currently being on the same level. The first participant to have, for example, three partial victories in a duel wins the duel, doubles his/her stake and advances to the next level, while the loser forfeits his/her stake and is eliminated from the game, however having the possibility to enter the game again later or directly through activating a new game session for a new entry fee. Alternatively a duel is decided through less or more than three partial victories.

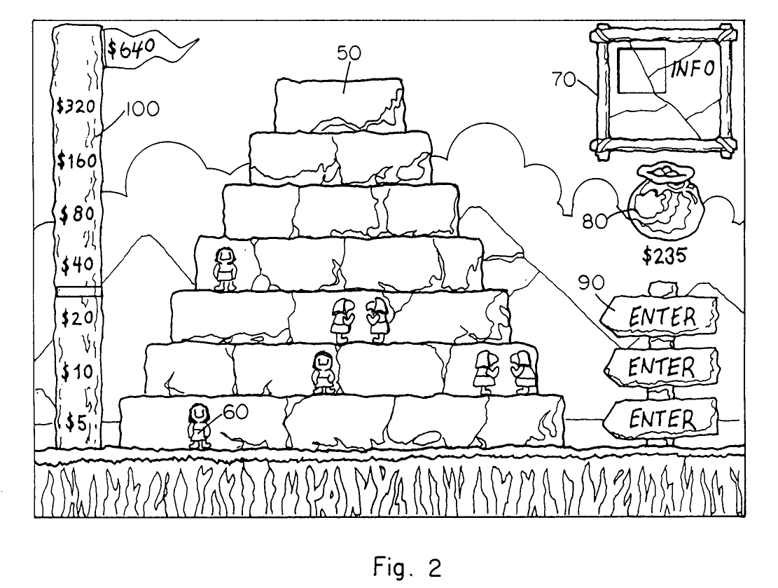

The course of events of a game are graphically illustrated in a main game window, according to one embodiment of the invention as shown in FIG. 2, in the form of a stepped pyramid 50 where each step of the pyramid represents a game level. In this embodiment of the invention, the stake increases the higher up on the pyramid 50 a participant advances. The participants in turn are graphically represented in the game by one or several small humanoids, so called avatars 60. The avatar or avatars of a certain participant preferably have a color separate from that of the opponents on the screen of that participant. For example if you play, your avatars are white and those of other participants are presented red on your screen. Alternatively any other different color combination could be used for said avatars.

Personal information, such as name or username, nationality, sex, age and the like personal information on the participant controlling a certain avatar is presented in a pop-up information window 70 that appears within the main game window upon clicking on that specific avatar. The balance of your account is indicated, for example within the symbol of a moneybag 80, and continuously updated in the currency valid for the specific game chosen. In one embodiment of the invention, a registering procedure has to be completed 5 before allowing a new participant access to the game. A player registration means then provides a new participant a registration fill-in form online through the game webpage, for example including fields for filling in personal data, such as name, address, age etc. When playing for valuables, such as money or monetary rewards, the fill-in form also includes fields for filling in financial data, such as bank account, credit card number or the like. The thus submitted personal and financial data together with a username and password chosen by the participant forms the individual player account. The data of said registered player account is stored in the network game database 40.

A data checkup procedure is preferably performed through a data authenticating means, wherein the authenticity of the registered data of said player account is verified, according to known procedures for data authentication, before access can be granted to a tournament duel game involving gambling for valuables.

The participant being granted access to the pyramid tournament duel game, through a game entry means provides that both a starting fee of real or fictitious value is drawn for each new avatar being entered into the game as well as that said avatar/avatars is entered into the game at a level chosen by the participant. It is, according to one embodiment of the invention, possible to choose between several points, i.e. levels, for game start and the starting fee or stake then varies depending on the starting level for the avatar. According to one embodiment of the invention the avatar 60 is entered into the game and the starting fee is drawn from the balance of the player account 80 by clicking with a pointer device on a graphical entry button 90, thus activating the game entry means, provided directly next to the corresponding pyramid level on which the participant chooses to let his/her avatar 60 start the pyramid game.

Starting the game at base level requires a basic starting fee or stake of a certain preset amount. Entering directly at the second level, for example, costs double as much and on the third level it costs four times the basic starting fee or stake. All levels there above though can only be reached through advancing by winning duels. Alternatively the entry level of the game can range from base level up to some levels from the top level depending on the number of total game levels. The fee/win amount for each level is, for example, shown next to the respective levels of the pyramid for the sake of clarity. In one embodiment of the invention, the fee/win amount for the levels are graphically presented level-wise on a post 100 standing next to and extending along the height of the pyramid 50.

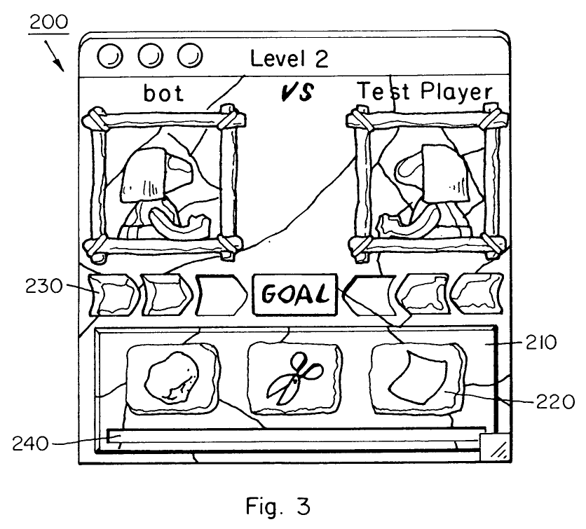

An avatar arriving at a pyramid level, either through an entry fee being paid or through winning a duel is, through a player pairing means, automatically paired with an available opponent avatar for a duel. Through the player pairing means, the avatars then on the screen of each participant are arranged to graphically walk towards and stands close to each other, “eye-to-eye”. A duel window 200, for example as exemplified in FIG. 3, where the duel will take place, is then simultaneously opened up on the respective screens of both dueling participants' computerized devices through a dueling means. The duel window 200 displays at least one of personal data, fetched from the database stored player account, comprising the respective participants name and/or username and the like personal information, close-ups on the avatars, a dialog box 210 displaying duel buttons 220, duel win indicating means in the form of mark spots 230 and remaining duel time 240 graphically. In the preferred embodiment of the tournament duel game, said duel buttons display a respective image of a rock, a scissor and a paper as can be seen in FIG. 3.

In one embodiment of the invention an extra chat box or the like communicating means is provided through a messaging means for the participants to chat with one another during a duel and/or when waiting for a duel. The messaging means is, for example, realized through ICO, SMS, email, or the like such known means for real time or time delayed messaging. Alternatively the messaging means is realized through known means for voice connection between the participants, engaged in- or waiting for a duel, through headsets or loudspeakers and microphones connected to their respective computerized devices. In the preferred embodiment of the game comprising RPS duels, when the three alternative duel buttons 220 with the respective symbols rock, scissors and paper are displayed by the dueling means, the participants have a preset amount of time to choose either one of the three symbols by pressing the corresponding button. The remaining time is then shown graphically diminishing at the bottom of the dialog box 210. A participant who has not chosen and with the pointer device, or through another means for selecting, pressed a duel button 220 on the screen of his/her computerized device within the preset time frame 240 is, through a random selection means, randomly assigned a button symbol alternative. When both participants have chosen or been assigned a button, the choices are displayed by the dueling means as symbols right next to respective avatar and if it is not a mirror play then the winner, according to the rules of the duel game, receives a mark on said mark spots 230 through said means. The procedure is repeated until one of the duelists has three marks and thus has won the duel.

The avatar of the loser is then, through an eliminating means, eliminated from the game. In the embodiment of the pyramid game form, it is then for example arranged for the avatar to graphically falloff the pyramid whilst screaming. A level advancing means provides that the winning avatar reaches the next game level. In the pyramid game form embodiment the avatar of the winner is arranged, through said means, to climb to the next pyramid level. The duel window is momentarily closed on the screen of the loser, but the winner is, through a winner selection means, presented with the opportunity to choose to either continue playing at the next level or to settle for the accumulated winnings and exit the tournament game. In the latter case, the avatar vanishes and the accumulated winnings are provided to the account of the winner participant. The winner on the highest pyramid level, where the participant has reached the terminal point of the tournament, collects the winnings according to the previously described procedure automatically through the winner selection means.

One embodiment of the invention comprises that each participant may enter up to four avatars into the same game simultaneously, which thus will participate in several mutually independent duels at the same time or almost simultaneously. Avatars of the same participant are then arranged not to be able to duel with each other but only with the avatars of other participants.

A lobby interface means, in a further embodiment of the invention, provides a game interface through which a participant is provided the means to personally adjust the settings of a game, such as to enable/disable sound, chat and/or talk with other participants through means for real time or time delayed messaging as those described above and to choose to enter an avatar into any of several different ongoing tournament duel games, for example having different pyramid sizes, i.e. levels, with different basic fees, currency, and maximum number of activated players.

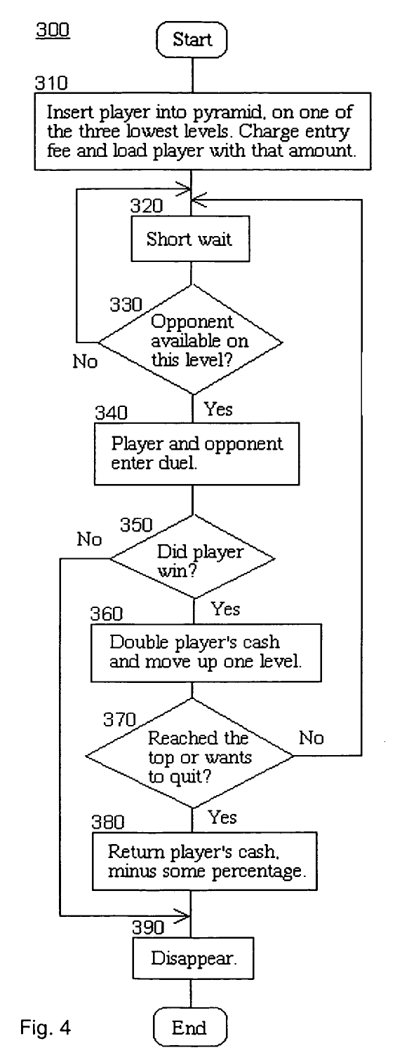

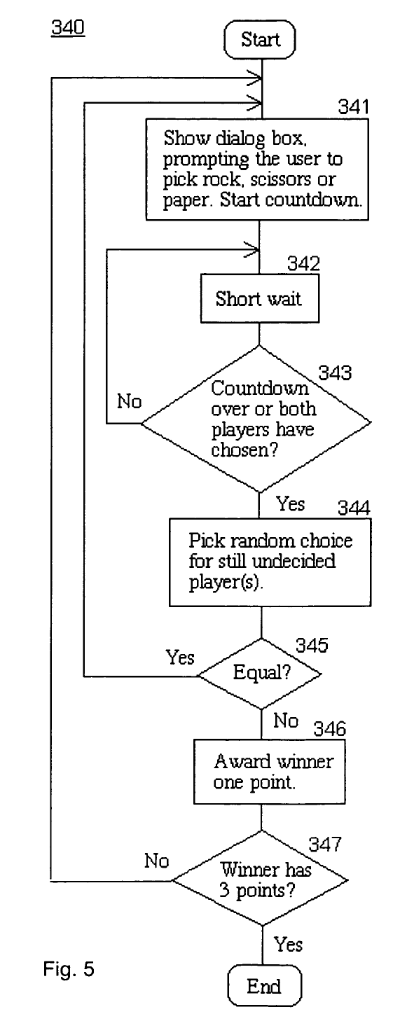

FIG. 4, according to one embodiment of the present invention, schematically depicts a flowchart of events, provided through software means, in a tournament duel game 300 comprising rock, scissors and paper matches between multiple participants on an Internet webpage to which the participants have access through their respective network connected personal computerized devices with screens. A player which is registered and authenticated for a pyramid duel game, for example according to the steps described above, inserts an avatar into the pyramid, for example the pyramid according to FIG. 2, on one of the three lowest pyramid levels according to procedures for game entry as described above. The entry fee is then charged and the avatar or player is loaded with that amount 310 through the game entry means. There is a short wait 320, for example between 2 to 10 seconds, before the player pairing means checks 330 for an available opponent on this level. If no opponent is available there is again a short wait 320, for example between 2 to 10 seconds, before a new opponent check 330 is performed through the means. If an opponent is available on this level, the dueling means initiates a duel 340 (see the description of FIG. 5 below, which in a flowchart illustrates the events of the duel 340 between two participants of the tournament PRS duel game 300). The network game server inherent software then checks, “Did the player win the duel” 350. If the answer is no, the player is eliminated from the game 390 through an eliminating means and the avatar then disappears. If the answer is yes, the player's valuables or cash is doubled 360 and the avatar advances one level up on the pyramid through level advancing means. The network game server inherent software then, through winner selection means, checks “Reached the top or wants to quit?” 370. If the answer is no, the duel game procedure is repeated beginning with short wait 320, before checking for an available opponent 330 on the new higher level and so forth. If the answer is 10 yes, the player's valuables or cash is returned 380 through the winner selection means and, according to one embodiment of the invention, a small percentage is deducted from the winnings. The player and avatar is then eliminated 390 from the game through the eliminating means and the game session is over for this player.

FIG. 5, according to one embodiment of the pyramid tournament duel game through a flowchart, illustrates the events of a duel 340 comprising a series of RPS matches between the player and an available opponent paired together via player pairing means on the same level of the pyramid tournament game 300 as described above in FIG. 4. A duel window 341 with a dialog box is opened simultaneously on the computerized screens of both the player and the opponent through the dueling means prompting each of these participants to pick a rock, scissors or paper symbol illustrated graphically via three different buttons in the box within a set countdown time illustrated by a graphically diminishing bar or line. There is a short wait 342, for example between 2 to 10 seconds, before “Countdown over or both players have chosen?” 343 is checked through the dueling means. If the answer is no, the procedure is repeated beginning again from short wait 342. If the answer is yes a random selection means picks a random choice of button symbol for still undecided players. The symbol chosen or randomly picked for the player is compared to that of the opponent for “Equality?” 345 through a symbol comparing means. If yes, the duel procedure is repeated beginning again with prompting the player to pick symbol button 341, etc. If no, the winner of the match is awarded one point or mark 346 through the dueling means. A point or mark counting means checks if “Winner has three points or marks?” 347. If no, the duel procedure is repeated beginning with prompting the player to pick symbol button 341, etc. If yes, then the duel is over.

The present invention thus accordingly through above described embodiments provides means for performing a real time network multi player tournament duel game for a reward, which requires a minimum of forehand knowledge and skill and which is quick, fun and exciting to play.

Means mentioned in the present description can be software means, hardware means or a combination of both.

The present invention has been described with non-limiting examples and embodiments. It is the attached set of claims that describe all possible embodiments for a person skilled in the art.

1. A network system including a game server and a game database connected to said server for storing at least one of game data and registered player data, for performing an online multilevel tournament duel game, hosted on said server connected to an open network for data and telecommunication between at least two players through a network connection via respective computerized devices, each with a screen, comprising:
game entry means for activating a player avatar on a certain game level of a preset number of total game levels depending on the size of a game bet provided from a redefined game account;
pairing means for checking if an opponent player is available on the certain game level;
dueling means for simultaneously opening up a duel window on the respective screens of both players when an available opponent player is found and upon which a countdown clock is started, said duel means for performing at least one duel match wherein each player is prompted to actively select, on said respective computerized screen and within a preset timeframe of said countdown clock, one of three different duel symbols displayed in said duel window, each symbol being first to one of the other two symbols and second to the other of the other two symbols;
random selection means for randomly selecting one of the three duel symbols for a player not having selected one of the three duel symbols within said preset timeframe;
symbol comparing means for comparing the selected duel symbols of the players when said preset timeframe has passed, wherein if the selected duel symbols upon comparison are found equal, the countdown clock is reset and the duel match is repeated, and wherein if the symbols are found not equal, the selected symbol being first to the other symbol selected determines a duel match winner;
wherein the system is arranged so that the winner of at least one duel match, through a level advancing means, advances one level in the game, doubles the game bet and is prompted, via said dual game window and utilizing winner selection means, to select one of transfer winnings to said predefined game account upon ending the game and engage a new duel match on the new game level, and wherein the system is arranged so that the loser of said at least one duel match, through eliminating means, is momentarily eliminated from said multilevel game.

2. A network system according to claim 1, further comprising duel match win indicating means for providing at least one of a graphical indication and an audible indication of a duel match win.

3. A network system according to claim 1, further comprising a duel match loss indicating means for providing at least one of a graphical indication and an audible indication of a duel match loss.

4. A network system according to claim 2, further comprising duel match win counting means arranged so that the first player to win three duel matches wins the duel.

5. A network system according to claim 1, further comprising messaging means for the players to communicate with one another.

6. A network system according to claim 5, wherein the messaging means utilizes at least one messaging systems chosen from the group consisting of email, means for real time messaging and means for time delayed messaging.

7. A network system according to claim 5, wherein the messaging means utilizes means for voice connection between the players through at least one of headsets, loudspeakers and microphones connected to their respective computerized devices.

8. A network system according to claim 1, further comprising lobby interface means for adjusting settings of the duel game.

9. A network system according to claim 8, wherein the settings are chosen from the group consisting of enabling sound, disabling sound and determining which of several different ongoing tournament duel games to enter.

10. A network method for performing an online multilevel tournament duel game between at least two players being connected to on an open network for data and telecommunication through respective computerized devices, each with a screen, wherein a network game server hosts said duel game and a network game database connected to said server stores at least one of game data and registered player data, comprising the steps of:
activating a player avatar on a certain game level of a preset number of total game levels depending on the size of a game bet provided from a predefined game account through a game entry means;
checking if an opponent player is available on the certain game level through pairing means;
randomly selecting one of the three duel symbols for a player not having selected one of the three symbols within said preset timeframe through random selection means; and
comparing the selected duel symbols of the players when said preset timeframe has passed through symbol comparing means, wherein if the selected duel symbols upon comparison are found equal, the countdown clock is reset and the duel match is repeated, and wherein if the symbols are found not equal, the selected symbol being first to the other symbol selected determines a duel match winner;
wherein the winner of at least one duel match, through a level advancing means, advances one level in the game, doubles the game bet and is prompted, via said duel game window and utilizing winner selection means, to select one of transfer winnings to said predefined game account upon ending the game and engage a new duel match on the new game level, wherein the loser of said at least one duel match, through eliminating means, is momentarily eliminated from said multilevel game.

11. A method according to claim 10, further including the step of indicating a duel match win by at least one of a graphical indicator and an audible indicator through duel match win indicating means.

12. A method according to claim 10, further including the step of indicating a duel match loss by at least one of a graphical indicator and an audible indicator through duel match loss indicating means.

13. A method according to claim 11, wherein the player who first wins three duel matches wins the duel.

14. A method according to claim 10, further including the step of adjusting settings of the game through a lobby interface means.

15. A method according to claim 14, wherein the settings are chosen from the group consisting of enabling sound, disabling sound and determining which of several different ongoing tournament duel games to enter.

16. A network software for performing an online multilevel tournament duel game hosted on a server connected to an open network for data and telecommunication between at least two players through a network connection via respective computerized devices, each with a screen, comprising:
game entry means for activating a player avatar on a certain game level of a preset number of total game levels depending on the size of a game bet provided from a predefined game account;
pairing means for checking if an opponent player is available on the certain game level;
dueling means for simultaneously opening up a duel window on the respective screens of both players when an available opponent is found and upon which a countdown clock is started, said duel means for performing at least one duel match wherein each player is prompted to actively select, on said respective computerized screen and within a preset timeframe of said countdown clock, one of three different duel symbols displayed in said duel window, each symbol being first to one of the other two symbols and second to the other of the other two symbols;
random selection means for randomly selecting one of the duel symbols for a player not having selected one of the three duel symbols within said preset timeframe; and
symbol comparing means for comparing the selected duel symbols of the players when said preset timeframe has passed, wherein if the selected duel symbols upon comparison are found equal, the countdown clock is reset and the duel match is repeated, and wherein if the symbols are found not equal, the selected symbol being first to the other symbol selected determines a duel match winner; and
wherein the software is arranged so that the winner of at least one duel match, through a level advancing means, advances one level in the game, doubles the game bet and is prompted, via a said duel window and utilizing winner selection means, to select one of transfer winnings to said predefined game account upon ending the game and engage a new duel match on the new game level, and wherein the software is arranged so that the loser of said at least one duel match, through eliminating means, is momentarily eliminated from said multilevel game.

17. A readable storage medium storing network software for performing an online multilevel tournament duel game hosted on a server connected to an open network for data and telecommunication between two players through a network connection via respective computerized devices, each with a screen, the network software comprising:
game entry means for activating a player avatar on a certain game level of a preset number of total game levels depending on the size of a game bet provided from a predefined game account;
pairing means when an available opponent is found for checking if an opponent player is available on the certain game level;
dueling means for simultaneously opening up a duel window on the respective screens of both players when an available opponent is found and upon which a countdown clock is started, said duel means for performing at least one duel match wherein each player is prompted to actively select, on said respective computerized screen and within a preset timeframe of said countdown clock, one of three different duel symbols displayed in said duel window, each symbol being first to one of the other two symbols and second to the other of the other two symbols;
random selection means for randomly selecting one of the duel symbols for a player not having selected one of the three duel symbols within said preset timeframe; and
symbol comparing means for comparing the selected duel symbols of the players when said preset timeframe has passed, wherein if the selected duel symbols upon comparison are found equal, the countdown clock is reset and the duel match is repeated, and wherein if the symbols are found not equal, the selected symbol being first to the other symbol selected determines a duel match winner; and
wherein the software is arranged so that the winner of at least one duel match, through a level advancing means, advances one level in the game, doubles the game bet and is prompted, via a said duel window and utilizing winner selection means, to select one of transfer winnings to said predefined game account upon ending the game and engage a new duel match on the new game level, and wherein the software is arranged so that the loser of said at least one duel match, through eliminating means, is momentarily eliminated from said multilevel game.
